(19) United States
(12) Patent Application Publication
(10) Pub. No.: US 2018/0225727 A1
(43) Pub. Date: Aug. 9, 2018

(54) SYSTEMS AND METHODS FOR GRAPHICAL-BASED CUSTOMER INTERACTION

(71) Applicant: JPMorgan Chase Bank, N.A., New York, NY (US)

(72) Inventors: Kingshuk Das, San Leandro, CA (US); Joseph Shields, Redwood City, CA (US); David Noonan, Columbus, OH (US); Jackie Liao, Pacifica, CA (US); Ash Aiwase, San Francisco, CA (US); Charisma Chan, Brooklyn, NY (US); Frederick Garcia, Oakland, CA (US)

(21) Appl. No.: 15/886,034

(22) Filed: Feb. 1, 2018

Related U.S. Application Data
(60) Provisional application No. 62/454,376, filed on Feb. 3, 2017.

(51) Int. Cl. G06Q 30/02; G06F 3/0482; G06F 3/0488

(52) U.S. Cl. CPC G06Q 30/0281; G06F 3/0488; G06F 3/0482

(57) ABSTRACT

Systems and methods for graphical-based customer interaction are disclosed. According to one embodiment, in an information processing apparatus comprising at least one computer processor, a method for graphical-based customer interaction may include: (1) receiving customer-specific information about a customer; (2) determining a plurality of topics to present to the customer based on the customer-specific information; (3) generating a tile for each topic, each tile comprising a graphic and content relevant to the topic; (4) generating a graphical information flow comprising the tiles, wherein the graphical information flow is linear; and (5) communicating the information flow to a mobile electronic device associated with the customer.

### RELATED APPLICATIONS

The present application claims the benefit of U.S. Provisional Patent Application Ser. No. 62/454,376, filed Feb. 3, 2017, the disclosure of which is hereby incorporated, by reference, in its entirety.

### BACKGROUND OF THE INVENTION

### 1. Field of the Invention

The present invention generally relates to systems and methods for graphical-based customer interaction.

### 2. Description of the Related Art

Mobile electronic devices, such as smartphones and tablet computers, have changed the way that information is presented us. Indeed, information that was once presented purely as text information is now presented graphically, which may make the underlying data, or analysis of that data, easier for the user of the mobile electronic device to understand.

### SUMMARY OF THE INVENTION

Systems and methods for graphical-based customer interaction are disclosed. According to one embodiment, in an information processing apparatus comprising at least one computer processor, a method for graphical-based customer interaction may include: (1) receiving customer-specific information about a customer; (2) determining a plurality of topics to present to the customer based on the customer-specific information; (3) generating a tile for each topic, each tile comprising a graphic and content relevant to the topic; (4) generating a graphical information flow comprising the tiles, wherein the graphical information flow is linear; and (5) communicating the information flow to a mobile electronic device associated with the customer.

In one embodiment, the method may further include ordering the tiles in the information flow based on a priority. The priority may be set by the customer, may be based on prior interactions with the customer, etc.

In one embodiment, at least one of the topics may be a recommendation based on a similarity between the customer and a third party that shares an affinity with the customer.

In one embodiment, the graphical information flow may be linear in a vertical direction relative to a display of the mobile electronic device. In another embodiment, the graphical information flow may be linear in a horizontal direction relative to a display of the mobile electronic device. In still another embodiment, the graphical information flow may be linear in a first direction relative to a display of the mobile electronic device and in a second direction relative to a display of the mobile electronic device, wherein the tiles for each topic may be presented in the first direction, and tiles related to each topic may be presented in the second direction.

In one embodiment, the tiles may be ordered such that a tile with a highest priority is presented first, and a tile with a second highest priority is presented second, regardless of a direction in which the graphical information flow is manipulated.

In one embodiment, the customer-specific information may be received from a third party.

According to another embodiment, in a mobile electronic device comprising a display and at least one computer processor, a method for graphical-based customer interaction may include: (1) receiving a graphical information flow comprising a plurality of tiles, wherein: each tile comprising a graphic and content relevant to a topic; the graphical information flow is linear; and the tiles are ordered in the graphical information flow based on a priority; (2) presenting, on the display of the mobile electronic device, a first tile of the plurality of tiles in the graphical information flow, the first tile having a highest priority of the plurality of tiles; (3) sensing, on an interface for the mobile electronic device, a gesture to manipulate the graphical information flow; and (4) presenting, on the display of the mobile electronic device, a second tile of the plurality of tiles in the graphical information flow, the second tile having a second highest priority of the plurality of tiles.

In one embodiment, the priority may be set by the customer, may be based on prior customer interactions, etc.

In one embodiment, at least one of the topics may be a recommendation based on a similarity between the customer and a third party that shares an affinity with the customer.

In one embodiment, the graphical information flow may be linear in a vertical direction relative to a display of the mobile electronic device. In another embodiment, the graphical information flow may be linear in a horizontal direction relative to a display of the mobile electronic device. In still another embodiment, the graphical information flow may be linear in a first direction relative to a display of the mobile electronic device and in a second direction relative to a display of the mobile electronic device, wherein the tiles for each topic may be presented in the first direction, and tiles related to each topic may be presented in the second direction.

In one embodiment, the tiles may be ordered such that a tile with a highest priority is presented first, and a tile with a second highest priority is presented second, regardless of a direction in which the graphical information flow is manipulated.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for graphical-based customer interaction to one embodiment;

FIG. 2 depicts a method for graphical-based customer interaction according to one embodiment;

FIG. 3 depicts exemplary tiles according to one embodiment; and

FIG. 4 depicts an exemplary linear graphical information flow progression according to one embodiment.

### DETAILED DESCRIPTION OF PREFERRED EMBODIMENTS

Embodiments disclosed herein are directed to systems and methods for graphical-based customer interaction.

Exemplary embodiments relate to providing a customized graphical mobile experience, for example, to a customer of a financial institution. The mobile experience may be engagement-focused, and may be a part of loyalty-related initiative or program that may be provided by the financial institution.

It should be recognized that the although this disclosure may be made in the context of a financial institution and financial information, it is not so limited and the disclosure may provide to applicability to other areas, accounts, and interests as is necessary and/or desired.

The various embodiments and their advantages may be understood by referring to the attached figures. It should be appreciated that the various examples in the attached figures are exemplary and non-limiting. For example, various exemplary user interfaces (UI's), tiles/cards, and graphical information flows are depicted, but various embodiments may have different UI's, tiles/cards, and graphical information flows as each may be customized for a particular customer.

Exemplary embodiments may be implemented as a computer application or program that may be executed by a mobile or portable electronic device (e.g., a smartphone, a tablet computer, etc.), an Internet of Things (“IoT”) appliance, etc. The computer application may be a stand-alone computer application. In various embodiments, the computer application may be a feature or a part of another computer application. For example, the computer application may be a part of a financial institution's mobile computer application, may be a feature that is accessible through the financial institution's mobile computer application, etc. In various embodiments, the financial institution's mobile computer application may be accessed from the computer application, and vice-versa.

Exemplary embodiments provide a graphical information flow to a customer's electronic device. The graphical information feed may include individual “cards” or “tiles” that may provide a picture, an illustration, a snapshot, information (e.g., account information), offers, etc. to a customer. For example, in the context of this disclosure the information flow may be related to the customer's finances and accounts with a financial institution. Other information flows, and contexts for those information flows, may be provided as is necessary and/or desired.

In one embodiment, the tiles or cards may be provided as a continuous flow that may be linear in a vertical direction (e.g., up and down relative to the display of the electronic device), linear in a horizontal direction, (e.g., left and right relative to the display of the electronic device), or in a combination of vertical and horizontal directions (e.g., the customer may select a broad topic in the vertical direction, and may be provided with greater details in the horizontal direction, or vice-versa). For example, a vertical flow may be used with options to move the flow left or right at certain cards. The customer may “swipe” or otherwise interact with the screen/display or an input device, or provide voice instructions, to implement the flow change in direction. The tiles or cards may serve as a UI for the customer to interact with. For example, a tile or card may provide one or more links, selection options, locations, etc. for the customer to interact with the tile/card, provide an input, etc.

Each tile or card may be tailored or customized for the customer based on information that may be available to the financial institution. In embodiments, information from third parties may be used to customize the tile or card for the customer. This information may be used in combination with the information from the financial institution. For example, the cards may display a combination of information from the financial institution and one or more third parties.

Embodiments may provide some or all of the following technical advantages: benefit reinforcement, task reminder, positive reinforcement, insight, automated background actions, insight-based origination, etc. In a financial scenario, embodiments may provide “bite-sized” financial news, social goal setting, etc. It may further provide partner-based rewards, messaging, etc.

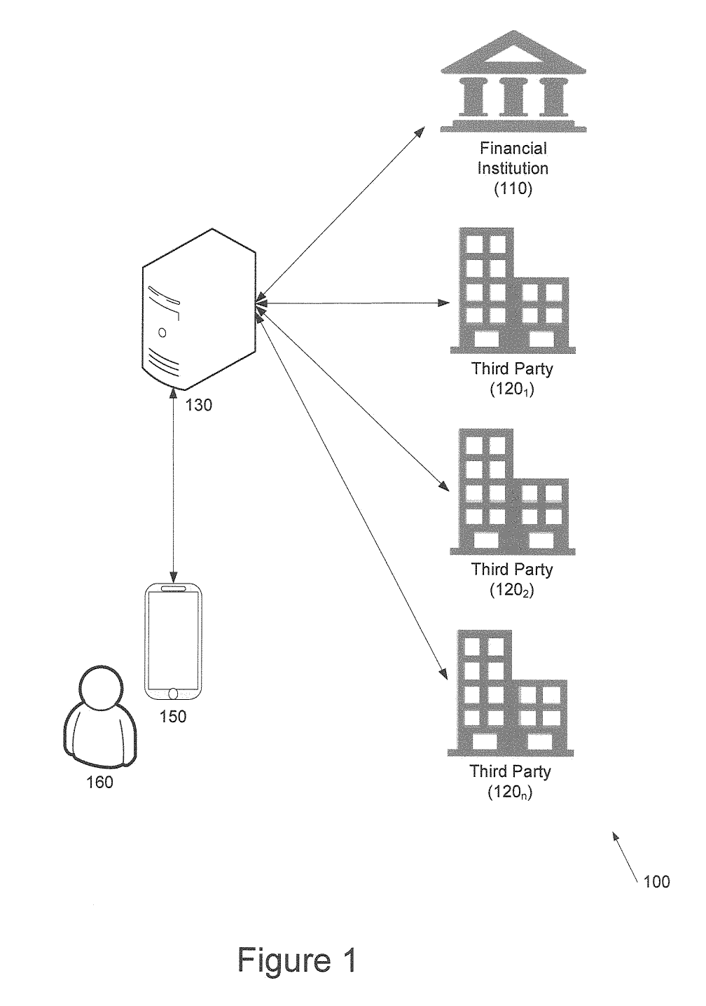

Referring to FIG. 1, a system for graphical-based customer interaction is disclosed according to one embodiment. System 100 may include host 110, which may be a financial institution, one or more third party 120, backend 130, and customer electronic device 150.

In one embodiment, host 110 may host one or more account for customer 160, such as a financial account (e.g., deposit, savings, mortgage, investment, credit card, etc.), a loyalty account, etc.

Third party 120 may host one or more account for customer 160, and may be a provider of a good or service for customer 160, etc. For example, third party 120 may be another financial institution, may be a merchant, etc.

In one embodiment, third party information may be received directly from third party 120. This may require, for example, customer consent and/or third party consent. In another embodiment, third party information may be received indirectly from third party 120, such as, a third party aggregator. In still another embodiment, third party information may be received from a third party application executed by electronic device 150. In still another embodiment, third party information may be gleaned from information that host 110 may have access to (e.g., on-line bill pay, etc.). Any suitable way of gathering and/or collecting third party information may be used as is necessary and/or desired.

In one embodiment, backend 130 may communicate with host 110, third party 120, etc. and electronic device 150. Backend 130 may execute one or more backend programs (not shown) that process the information received, and may provide processed information to a computer program executed by electronic device 150.

In one embodiment, electronic device 150 may be any suitable electronic device, including, for example, workstations, notebook computers, tablet computers, smartphones, smart watches, game may be executed by a mobile or portable electronic device, an Internet of Things (“IoT”) appliance, etc.

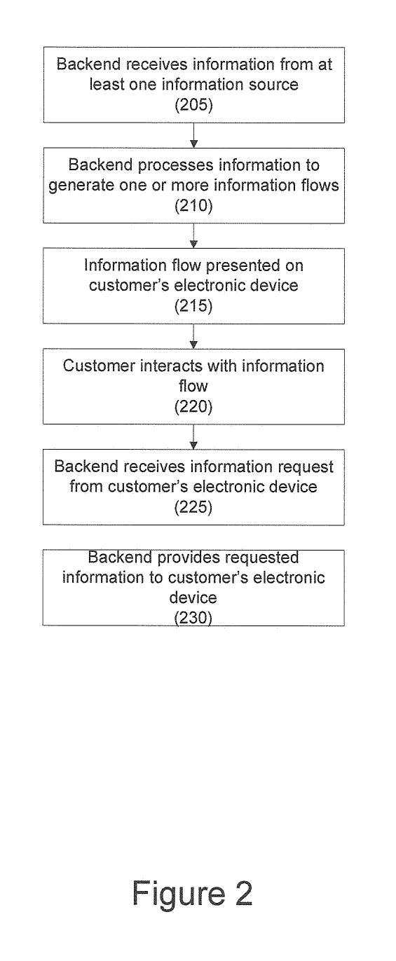

Referring to FIG. 2, a method for graphical-based customer interaction is disclosed according to one embodiment. In step 205, a backend may receive information from at least one information source. For example, the backend may receive information from a host (e.g., a financial institution) about the customer's accounts, from one or more third party (e.g., merchants, aggregators, etc.), etc.

In one embodiment, the backend may also receive information from the customer's electronic device. This may include, for example, location information, information from third party applications, etc.

In one embodiment, the information may include financial information, rewards/loyalty information, transaction information, etc.

In step 210, the backend may process the received information to create at least one information flow. In one embodiment, the flow may comprise a plurality of tiles or cards, and each tile or card may be associated with a topic that may be related to at least some of the information processed by the backend. For example, the backend may identify trends (e.g., spending trends), outliers, goods or services to market (e.g., offers for a credit card that may offer better rewards), spending tips, upcoming events that may be of interest, comparisons to or recommendations based on similarly-situated people or groups of people, etc. For example, one of more affinity with one or more third party that shares common interests (e.g., merchants, purchases, demographics, etc.) may be used to identify interests, provide comparisons to, or provide recommendations.

Exemplary systems and methods for identifying similarly-situated people, their interests, and their affinities are disclosed in U.S. patent application Ser. No. 14/878,395, filed Oct. 8, 2015, and U.S. Patent Application Ser. No. 62/134,959, filed Mar. 18, 2015. The disclosures of each of these documents is hereby incorporated, by reference, in its entirety.

In one embodiment, the offers may be based on location. For example, if a customer is near a donut shop, and customer has a history of donut purchases, the information flow may include an offer from the donut shop.

In one embodiment, the location (e.g., GPS location) of the mobile electronic device may also increase the priority of a tile in the information flow. For example, if the customer is being presented with an offer from a merchant, and it is determined that the customer is near the merchant's location, the priority of the tile in the information flow may be increased.

Conversely, if the customer is not near the merchant, the priority of the tile may be decreased.

In one embodiment, the information flow may be organized as a vertical flow (e.g., up and down relative to the display of the electronic device) or a horizontal flow (e.g., left and right relative to the screen). For example, the customer may interact with the information flow by touching the display of the electronic device and making an upward, downward, left, or right gesture or swipe. The customer may also interact with the information flow by providing an input to a keypad, touchpad, mouse, or provide a voice command.

In one embodiment, information from external devices may also be used to generate or prioritize tiles. For example, a fitness tracker, such as a step counter, may be used to earn rewards (e.g., take 10,000 steps today to earn rewards points). The information may be received from an application executed on the customer's electronic device, from a third party, etc.

In one embodiment, the information flow may comprise both a vertical flow and a horizontal flow. For example, tiles or cards with high-level topics (e.g., checking account, savings account, offers, etc.) may be provided in the vertical flow, and sub-topics for the high-level topics may be provided in the horizontal flow (e.g., balance, payment due date, etc.). Thus, if the customer swipes to the right or left when a high-level topic is presented, additional tiles related the high-level topic may be provided (e.g., trends, detailed information, recommendations, etc.).

As another example, the high-level tiles may be provided in the horizontal flow, and the detailed tiles may be presented in the vertical flow. In one embodiment, the customer may configure which information flow provides the high-level tiles, and which presents the detailed tiles.

In one embodiment, the ranking or order in which the tiles or cards are presented may be based on, for example, other customers with similar interests, affinities, etc., machine learning from prior interactions, etc.

In step 215, the information flow may be provided to, and presented on, the customer's electronic device. In one embodiment, the information flow may be organized so that the second ordered or ranked tile or card is presented regardless of the direction that the customer “moves” the flow. For example, regardless as to whether the customer swipes up or down to interact with the flow, the second tile or card that is presented is the second ranked or ordered tile or card.

In step 220, the customer may interact with the information flow as discussed above.

In step 225, the backend may receive an information request from the customer's electronic device, and in step 230, the backend may provide the requested information to the customer's electronic device as is necessary and/or desired.

In one embodiment, the customer may be offered a credit card, and may only need to accept the terms and conditions for the card or an electronic token to be provisioned to the customer's electronic device.

In one embodiment, after the information flow is presented, the customer may actively or passively provide one or more inputs to refine how the system tiles or cards will be ranked during the next interaction. For example, machine learning may be used to identify the high-level topics that will be presented based on, for example, the customer's current interaction. For example, if the customer interacts with, spends time viewing, etc. a tile or card, that tile or card will more likely to be presented in the next information flow than had the customer not interacted with that tile or card.

In one embodiment, behavioral analytics (e.g., time spent on viewing a tile or card, etc.) or actual customer input (e.g., tapping “I want to see this first”) may be used to order and/or rank the tiles or cards.

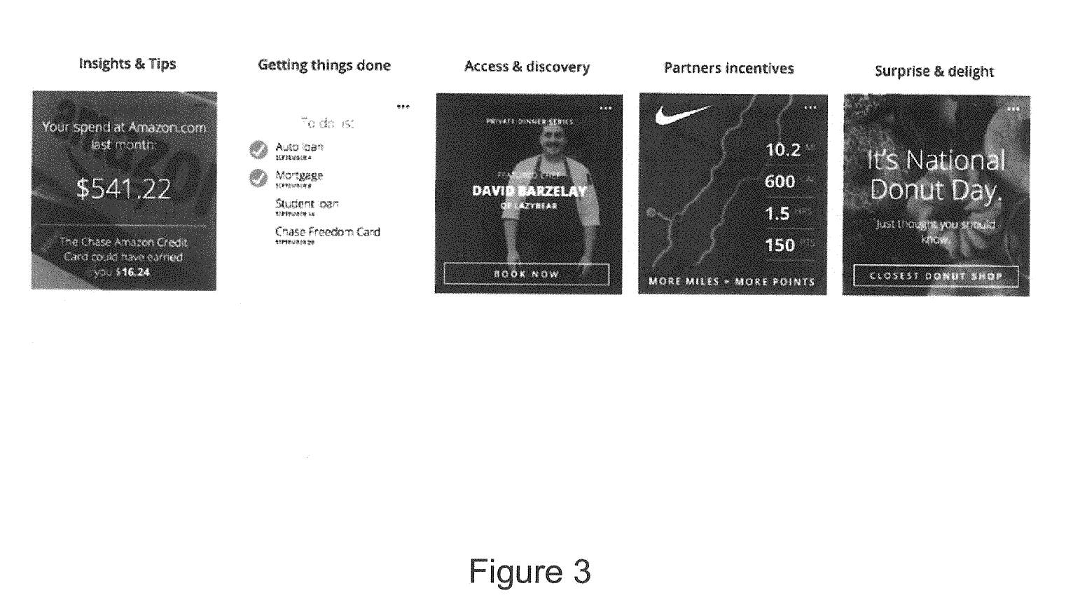

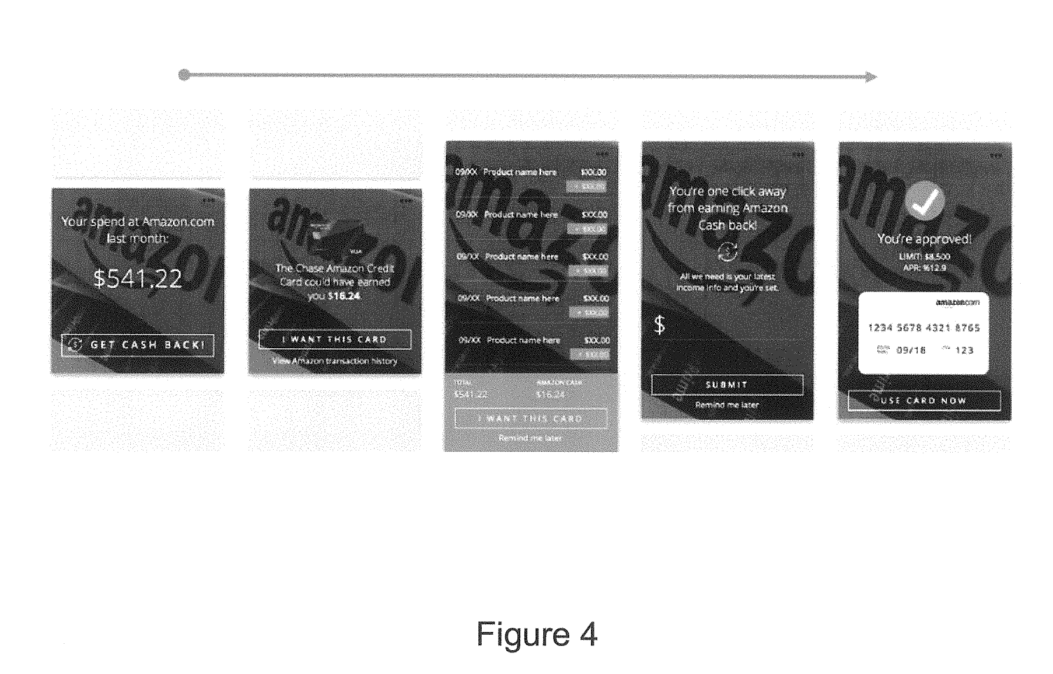

Illustrative tiles are provided in FIGS. 3 and 4. Specifically, FIG. 3 depicts exemplary tiles for a plurality of topics, including, for example, insights and tips, getting things done, access and discovery, partner incentives, and surprise and delights. Note that these topics are exemplary only, and other topics may be used as necessary and/or desired.

FIG. 4 illustrates an exemplary linear graphical information flow progression of a plurality of tiles. Again, this linear flow is illustrative only, and illustrates the linear progression among a plurality of topics.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a customer or customers of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for graphical-based customer interaction, comprising:
in an information processing apparatus comprising at least one computer processor:
receiving customer-specific information about a customer;
determining a plurality of topics to present to the customer based on the customer-specific information;
generating a tile for each topic, each tile comprising a graphic and content relevant to the topic;
generating a graphical information flow comprising the tiles, wherein the graphical information flow is linear; and
communicating the information flow to a mobile electronic device associated with the customer.

2. The method of claim 1, further comprising:
ordering the tiles in the information flow based on a priority.

3. The method of claim 2, wherein the priority is set by the customer.

4. The method of claim 2, wherein the priority is based on prior interactions with the customer.

5. The method of claim 1, wherein at least one of the topics is a recommendation based on a similarity between the customer and a third party that shares an affinity with the customer.

6. The method of claim 1, wherein the graphical information flow is linear in a vertical direction relative to a display of the mobile electronic device.

7. The method of claim 1, wherein the graphical information flow is linear in a horizontal direction relative to a display of the mobile electronic device.

8. The method of claim 1, wherein the graphical information flow is linear in a first direction relative to a display of the mobile electronic device and in a second direction relative to a display of the mobile electronic device, wherein the tiles for each topic are presented in the first direction, and tiles related to each topic are presented in the second direction.

9. The method of claim 2, wherein the tiles are ordered such that a tile with a highest priority is presented first, and a tile with a second highest priority is presented second, regardless of a direction in which the graphical information flow is manipulated.

10. The method of claim 1, wherein the customer-specific information is received from a third party.

11. A method for graphical-based customer interaction, comprising:
in a mobile electronic device comprising a display and at least one computer processor:
receiving a graphical information flow comprising a plurality of tiles, wherein:
each tile comprising a graphic and content relevant to a topic;
the graphical information flow is linear; and
the tiles are ordered in the graphical information flow based on a priority;
presenting, on the display of the mobile electronic device, a first tile of the plurality of tiles in the graphical information flow, the first tile having a highest priority of the plurality of tiles;
sensing, on an interface for the mobile electronic device, a gesture to manipulate the graphical information flow; and
presenting, on the display of the mobile electronic device, a second tile of the plurality of tiles in the graphical information flow, the second tile having a second highest priority of the plurality of tiles.

12. The method of claim 11, wherein the priority is set by the customer.

13. The method of claim 11, wherein the priority is based on prior customer interactions.

14. The method of claim 11, wherein at least one of the topics is a recommendation based on a similarity between the customer and a third party that shares an affinity with the customer.

15. The method of claim 11, wherein the graphical information flow is linear in a vertical direction relative to a display of the mobile electronic device.

16. The method of claim 11, wherein the graphical information flow is linear in a horizontal direction relative to a display of the mobile electronic device.

17. The method of claim 11, wherein the graphical information flow is linear in a first direction relative to a display of the mobile electronic device and in a second direction relative to a display of the mobile electronic device, wherein the tiles for each topic are presented in the first direction, and tiles related to each topic are presented in the second direction.

18. The method of claim 11, wherein the tiles are ordered such that a tile with a highest priority is presented first, and a tile with a second highest priority is presented second, regardless of a direction in which the graphical information flow is manipulated.
